(19) United States
(12) Patent Application Publication
(10) Pub. No.: US 2025/0077135 A1
(43) Pub. Date: Mar. 6, 2025

(54) IMAGE FORMING APPARATUS AND METHOD FOR CONTROLLING THE SAME

(71) Applicant: CANON KABUSHIKI KAISHA, Tokyo (JP)

(72) Inventor: TAKASHI FUJII, Tokyo (JP)

(21) Appl. No.: 18/815,612

(22) Filed: Aug. 26, 2024

(30) Foreign Application Priority Data
Aug. 29, 2023 (JP) 2023-138696

(51) Int. Cl. G06F 3/12

(52) U.S. Cl. CPC G06F 3/1208; G06F 3/1239

(57) ABSTRACT

An image forming apparatus includes an printer configured to execute first print processing using a decolorable recording material or second print processing using a undecolorable recording material, a first paper feed stage loaded with decolored paper with a printed image having been decolored, and a second paper feed stage loaded with unused paper, wherein, in a case where a user for whom charge submission processing is executed through a single login to the image forming apparatus executes print processing, the printer uses the second paper feed stage but does not use the first paper feed stage.

### BACKGROUND

### Field of the Disclosure

The present disclosure relates to an image forming apparatus and a method for controlling the image forming apparatus.

### Description of the Related Art

With the increase in the environmental awareness in recent years, there has been a demand for reusing paper printed by an image forming apparatus. A certain image forming apparatus is known to support not only normal toner printing but also decoloring toner printing for enabling the reuse of paper (for example, see Japanese Patent Application Laid-Open No. 2018-072809).

If paper printed with decoloring toner is processed by using a decoloring apparatus, decoloring toner can be decolored allowing the user to reuse the paper. The color material of decoloring toner is a capsule-shaped coloring particle containing a coloring compound, a developer, and a decoloring agent. This coloring particle is decolored when heated to a first temperature or higher and is colored when cooled down to a second temperature (lower than the first temperature) or lower after being decolored (for example, see Japanese Patent Application Laid-Open No. 2015-166886).

Image forming apparatuses are installed in public facilities such as convenience stores. Image forming apparatuses on these locations are connected with a coin vendor for the charge submission and are provided with a mechanism for executing a copy operation after the charge submission. However, if an owner (employee) uses an image forming apparatus provided with such a coin vendor, the owner cancels the coin vendor function to disable the charge collection function before each use.

To improve such usability, an operation form called a half public mode is currently being applied. For example, in a cram school, if a student wants to use an image forming apparatus, the student logs into the apparatus via the coin vendor. If an employee wants to use the image forming apparatus, the employee logs into the apparatus from the operation unit without using the coin vendor. In this use form, one image forming apparatus is effectively utilized. There is discussed an image forming apparatus having a charge collection function and enabling the switching between a charge management mode (for general users) and a non-charge management mode (for administrators and service personnels) (for example, see Japanese Patent Application Laid-Open No. 11-258954).

### SUMMARY

According to an aspect of the present disclosure, an image forming apparatus includes a printer configured to execute first print processing using a decolorable recording material or second print processing using a undecolorable recording material, a first paper feed stage loaded with decolored paper with a printed image having been decolored, and a second paper feed stage loaded with unused paper, wherein, in a case where a user for whom charge submission processing is executed through a single login to the image forming apparatus executes print processing, the printer uses the second paper feed stage but does not use the first paper feed stage.

Further features of various embodiments will become apparent from the following description of exemplary embodiments with reference to the attached drawings.

### BRIEF DESCRIPTION OF THE DRAWINGS

FIG. 1 is a block diagram illustrating a hardware configuration of an image forming apparatus.

FIG. 2 illustrates various programs stored in a Read Only Memory (ROM).

FIG. 3 illustrates data configuration of an authentication table.

FIG. 4 is a flowchart illustrating print processing of the image forming apparatus.

FIG. 5 is a flowchart illustrating login processing of the image forming apparatus.

FIGS. 6A to 6C illustrate a printing system.

FIG. 7 is another flowchart illustrating print processing of the image forming apparatus.

FIG. 8 is a flowchart illustrating processing for locking and unlocking a decolored paper feeding unit.

### DESCRIPTION OF THE EMBODIMENTS

Exemplary embodiments of the present disclosure will be described below with reference to the accompanying drawings. The following exemplary embodiments do not limit every embodiment of the present disclosure within the scope of the appended claims. Not all of the combinations of the features described in the exemplary embodiments are indispensable to the solutions for the present disclosure. The present exemplary embodiment will be described below centering on an image forming apparatus as an example of an information processing apparatus, but the present exemplary embodiment is not limited to the image forming apparatus.

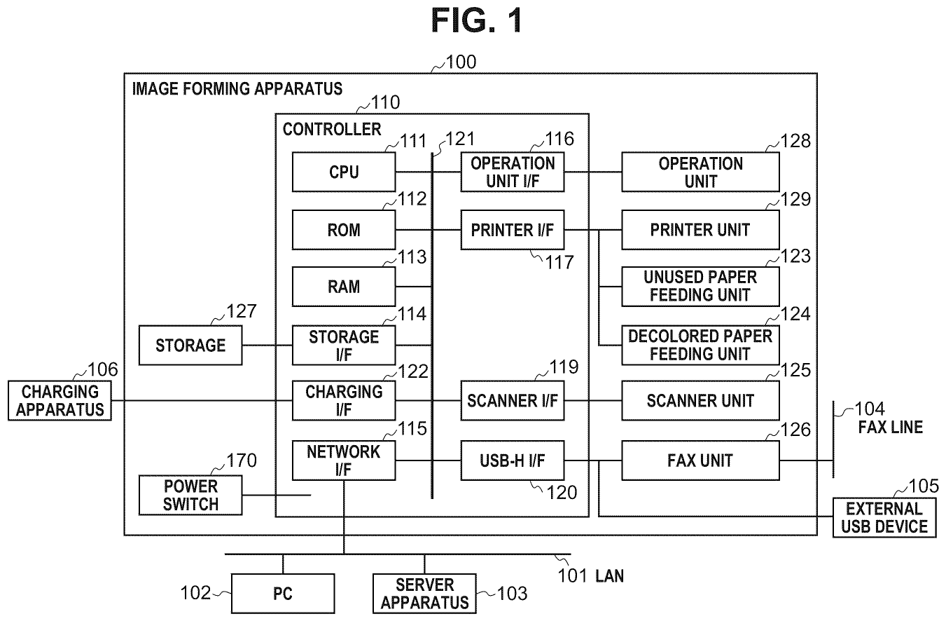

A first exemplary embodiment will be described below. FIG. 1 is a block diagram illustrating a hardware configuration of an image forming apparatus 100. The image forming apparatus 100 includes a controller 110, a storage 127, an operation unit 128, a printer unit 129, an unused paper feeding unit 123, a decolored paper feeding unit 124, a scanner unit 125, and a FAX unit 126. The controller 110 controls different components (including the storage 127, the operation unit 128, the printer unit 129, the scanner unit 125, and the FAX unit 126) of the image forming apparatus 100. The controller 110 includes a Central Processing Unit (CPU) 111, a Read Only Memory (ROM) 112, and a Random Access Memory (RAM) 113. The controller 110 further includes a storage interface (I/F) 114, a network I/F 115, an operation unit I/F 116, a printer I/F 117, a scanner I/F 119, and Universal Serial Bus (USB)-Host I/F 120.

The CPU 111 controls peripheral devices for the CPU 111 and executes data calculation processing. A system bus 121 is a transmission line used by the CPU 111 and devices to access other devices. The CPU 111 loads various programs stored in the ROM 112 into the RAM 113 and then executes the programs. The RAM 113 is used as a work memory by the CPU 111.

The storage 127 is connected with the storage I/F 114. The storage 127 stores various programs (databases and image files) necessary for the operation of the image forming apparatus 100. The storage 127 is, for example, an external storage device such as a Hard Disk Drive (HDD) and Solid State Drive (SSD), and may be an Embedded Multi Media Card (eMMC) with a built-in controller. The operation unit I/F 116 is connected with the operation unit 128. The operation unit 128 transmits an instruction input by the user to the CPU 111 via the operation unit I/F 116.

The operation unit 128 includes, for example, a display, a keyboard, hardware keys, and touch sensors.

The network I/F 115 connected with a network cable (e.g., LAN cable) communicates with other devices (such as a personal computer (PC) 102 and a server apparatus 103) communicably connected via a Local Area Network (LAN) 101. The PC 102 enables transmission and reception of print data and operations of the image forming apparatus 100 via a web browser.

A power switch 170 is connected with the controller 110. When the power switch 170 is ON, power is supplied to at least a part of the controller 110. Even when the power switch 170 is turned off, the power supply to each component is not immediately stopped. The controller 110 waits until software and hardware components suitably terminate and then stops supplying power to components other than ones necessary to turn the power switch 170 back on. The power switch 170 may be displayed on the display of the operation unit 128 and then a displayed power key is selected. Also, the power switch 170 may be installed as a hardware key on the operation unit 128 or the main body of the image forming apparatus 100.

The printer I/F 117 is connected with the printer unit 129 (printing unit), the unused paper feeding unit 123, and the decolored paper feeding unit 124. The printer unit 129 performs a print operation based on the image data received from the printer I/F 117. According to the present exemplary embodiment, the printer unit 129 includes a controller (not illustrated) and has a function of switching the toner type to be used for forming an image on a sheet between the normal toner (undecolorable toner) and the decoloring toner (decolorable toner). The printer unit 129 has a function of adjusting the image forming process, such as the paper conveyance speed and the fixing temperature, based on the relevant output toner type. For example, the printer unit 129 differentiates the fixing roller temperature and the removal roller temperature between a case of printing with the normal toner, a case of printing with the decoloring toner, and a case of removing toner from a sheet printed with the decoloring toner. According to the present exemplary embodiment, print processing using the decoloring toner is referred to as decoloring print processing (first print processing), and print processing using the undecolorable (normal) toner is referred to as normal print processing (second print processing). A print product produced by the decoloring print processing is heated at a predetermined temperature so that an image printed with the decoloring toner becomes invisible to the user, allowing the user to reuse paper. The predetermined temperature is, for example, a temperature higher than the fixing temperature at the time of printing.

Examples of applicable image forming methods include the ink-jet printing method using ink as a recording material as well as the electrophotographic method using toner as a recording material. In this case, “output toner type”, “normal toner”, and “decoloring toner” according to the present exemplary embodiment are to be replaced with “output ink type”, “normal ink”, and “decoloring ink”, respectively. The printer unit 129 may be provided with recording materials of a plurality of colors to be configured to execute color printing. A decoloring function is provided as a function of the image forming apparatus 100 or an independent apparatus. Generally, the decoloring function cannot completely restore printed paper to pure white paper. Dense images may not be completely decolored, resulting in remaining color portions. There may be a case where the decoloring function cannot be used as expected if a print product has a large image printing ratio or includes a large printing target image.

The unused paper feeding unit 123 (second paper feed stage) and the decolored paper feeding unit 124 (first paper feed stage) are paper feeding apparatuses for controlling the paper feed operation, conveyance operation, and paper feed stage locking operation via rollers and various sensors. The unused paper feeding unit 123 is loaded with unused (new) paper. The decolored paper feeding unit 124 is loaded with paper from which the decoloring toner has been removed by the decoloring function, and is locked through a key or number lock.

The scanner I/F 119 is connected with the scanner unit 125 (reading unit). The scanner unit 125 reads an image on a document, generates image data, and transmits the image data to the scanner I/F 119. The scanner I/F 119 stores the image data in the storage 127. The USB-Host I/F 120 communicates with a USB device communicably connected with the USB-Host.

According to the present exemplary embodiment, the controller 110 and the FAX unit 126 are connected. The FAX unit 126 transmits FAX data to a FAX circuit 104 based on the image data received via the USB-Host I/F 120. More specifically, the FAX unit 126 generates image data based on FAX data received from the FAX circuit 104 and transfers the relevant image data to the storage 127 via the USB-Host I/F 120. The USB-Host I/F 120 is also connectable with an external USB device 105. The external USB device 105 is a USB memory or a USB keyboard. When the power switch 170 is on, power is supplied to at least a part of the controller 110.

Even when the power switch 170 is turned off, the power supply to each component is not immediately stopped. The controller 110 waits until software and hardware components suitably terminate and then stops supplying power to components other than ones necessary to turn the power switch 170 back on. The power switch 170 may be displayed on the display of the operation unit 128 and then a displayed power key is selected. Also, the power switch 170 may be installed as a hardware key on the operation unit 128 or the main body of the image forming apparatus 100.

A charging I/F 122 is connected with a charging apparatus 106. For example, when a charging target user inputs coins and bank notes to the charging apparatus 106, the CPU 111 may be notified of information about the input amount of currency from the charging apparatus 106 via the charging I/F 122. When the charging apparatus 106 performs charging processing, the charging apparatus 106 may be notified of information about the amount of charge to be checked off from the CPU 11 via the charging I/F 122. FIG. 1 illustrates a case where the image forming apparatus 100 is connected with the charging apparatus 106 as an external apparatus of the image forming apparatus 100. There may be an embodiment form where the image forming apparatus 100 and the charging apparatus 106 are integrated, and the operation unit of the image forming apparatus 100 is provided with a coin slot.

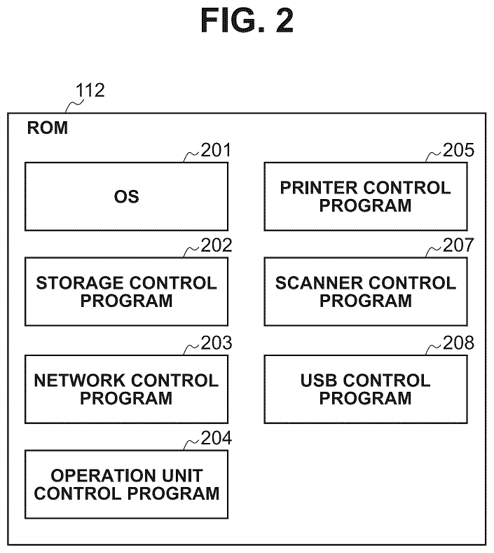

FIG. 2 illustrates various programs stored in the ROM 112. An Operating System (OS) 201 is executed by the CPU 111 to manage various processes and memory resources and control the controller 110. A storage control program 202 is used for controlling the storage 127 via the storage I/F 114. A network control program 203 transmits and receives a packet to the LAN 101 connected via the network I/F 115 and analyzes a packet.

An operation unit control program 204 is used for controlling the operation unit 128 via the operation unit I/F 116. A printer control program 205 is used for controlling the printer unit 129, the unused paper feeding unit 123, and the decolored paper feeding unit 124 via the printer I/F 117. The printer control program 205 is used for controlling locking and unlocking of the decolored paper feeding unit 124 based on the user identifier (ID) permitted for “use of decolored paper” based on an authentication table (described below).

The scanner control program 207 is used for controlling the scanner unit 125 via the scanner I/F 119. The USB control program 208 is used for controlling a USB device via the USB-Host I/F 120.

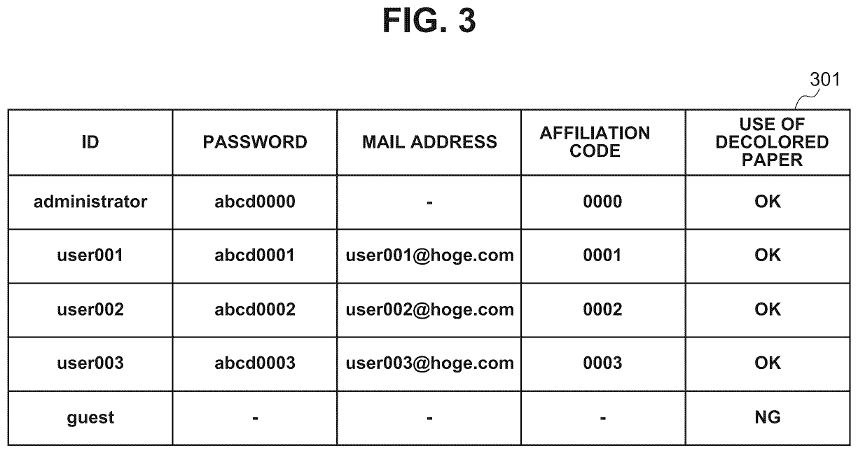

FIG. 3 illustrates a data configuration of the authentication table. An authentication table 301 is stored in the ROM 112 or the storage 127. Information stored in the authentication table 301 includes the “ID” uniquely assigned to the user, “password” used for authentication, “mail address” of the user, “affiliation code” indicating the user's affiliation section, and permission or inhibition for “use of decolored paper”. A “guest” user is a charging target user who can log into the image forming apparatus 100 by inputting the charge for print processing (with coins, bank notes, digital currency, etc.) to the charging apparatus 106. Upon completion of the print processing through the execution of a print job, the charging target user performs processing for checking off the charge for the executed print processing from the input amount of currency. In other words, the charge submission is performed through a single login. For other identifiable individual users, the charge submission processing is collectively performed at a specific timing such as the end of month or in unit of a specific group (e.g., in unit of organization). In other words, the charge submission processing is not performed through a single login.

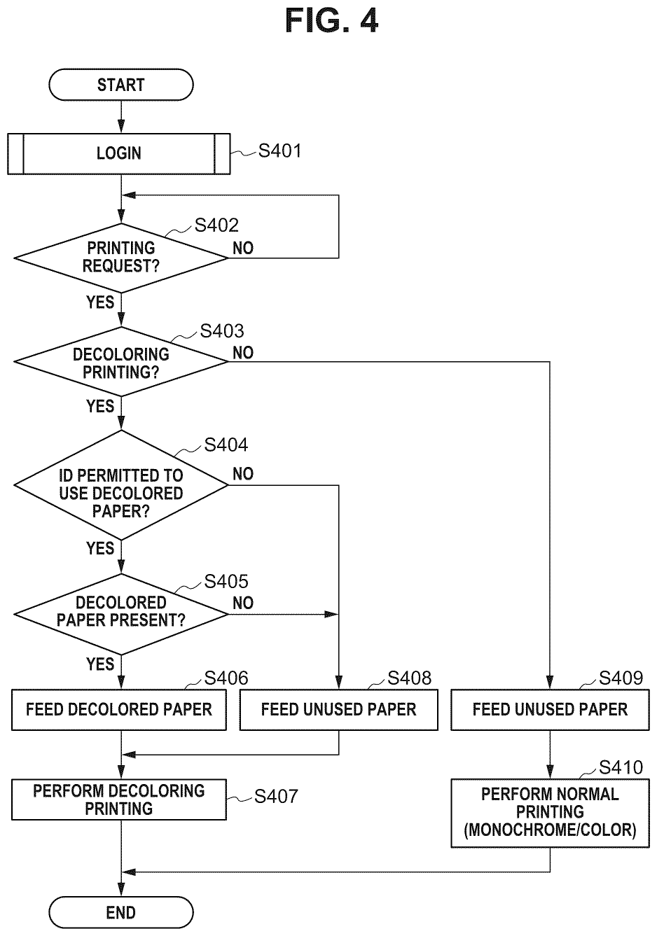

FIG. 4 is a flowchart illustrating print processing of the image forming apparatus 100.

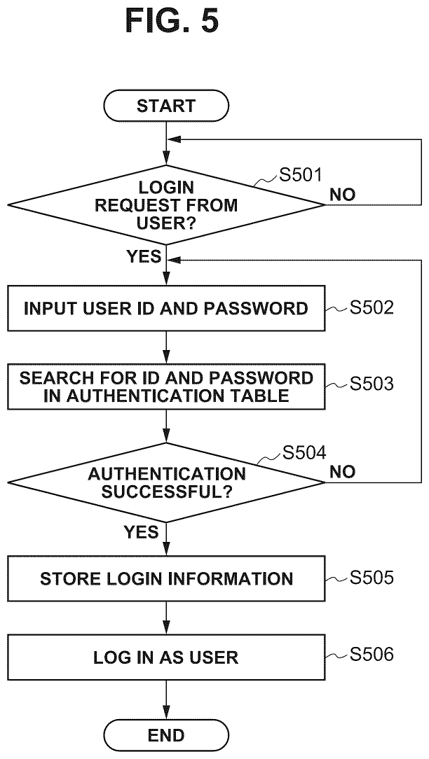

In step S401, the CPU 111 executes user login processing. The login processing will be described in detail below with reference to FIG. 5.

In step S402, the CPU 111 determines whether a print request is received from the user. If the print request is received (YES in step S402), the processing proceeds to step S403. If the print request is not received (NO in step S402), the CPU 111 waits until the print request is received. A print request is issued, for example, when a print start button (not illustrated) placed on the operation unit 128 is pressed or when a print job is received via a network.

In step S403, the CPU 111 determines whether the print request from the user is a request for decoloring printing using the decoloring toner. If the print request is a decoloring printing request (YES in step S403), the processing proceeds to step S404. If the print request is not a decoloring printing request, i.e., the print request is a normal printing request (NO in step S403), the processing proceeds to step S409.

In step S404, the CPU 111 searches for the ID in the authentication table and determines whether the login user is permitted to use decolored paper. If the user is permitted to use decolored paper (YES in step S404), the processing proceeds to step S405. If the user is not permitted to use decoded paper (NO in step 404), the processing proceeds to step S408.

In step S405, the printer control program 205 checks whether decolored paper is present in the decolored paper feeding unit 124. If decolored paper is present (YES in step S405), the processing proceeds to step S406. If decolored paper is not present (NO in step S405), the processing proceeds to step S408. In the above-described processing, if decolored paper is not present, the processing proceeds to step S408. However, if a notification for promoting a user to replenish decolored paper is issued and decolored paper is replenished, the processing may proceed to step S405. If a notification for skipping the replenishment is issued, the processing may proceed to step S408.

In step S406, the printer control program 205 feeds decolored paper from the decolored paper feeding unit 124 to the printer unit 129. In step S407, the printer control program 205 subjects the fed paper to the decoloring print processing by using the decoloring toner.

In step S408, the printer control program 205 feeds unused paper from the unused paper feeding unit 123 to the printer unit 129. Then, the processing proceeds to step S407. In step S409, a paper feeding unit control program 206 feeds the unused paper from the unused paper feeding unit 123 to the printer unit 129. Then, the processing proceeds to step S410. The unused paper feeding unit 123 is used in the above-described example. However, if the login user is permitted to use decolored paper, a paper feed stage is set according to a setting of the print job. More specifically, if the user is permitted to use decolored paper and the decolored paper feeding unit 124 is set in the print setting, decolored paper is fed from the decolored paper feeding unit 124.

In step S410, the printer control program 205 subjects the fed paper to the normal print processing by using the normal toner (undecolorable toner).

FIG. 5 is a flowchart illustrating login processing of the image forming apparatus 100.

In step S501, the CPU 111 checks whether the operation unit 128 receives a login request from the user. If the login request is received (YES in step S501), the processing proceeds to step S502. If the login request is not received (NO in step S501), the CPU 111 waits in step S501 until the login request is received.

In step S502, the CPU 111 accepts the user ID and password input from the operation unit 128.

In step S503, the CPU 111 searches for the input ID and password in the authentication table 301.

In step S504, the CPU 111 determines whether the input ID and password are authenticated based on the authentication table 301. If the input ID and password are authenticated (YES in step S504), the processing proceeds to step S505.

If the input ID or password is not authenticated (NO in step S504), the processing returns to step S502. In step S502, the CPU 111 prompts the user to input the user ID and password again.

In step S505, the CPU 111 stores the input ID as a login user in the ROM 112 or storage 127.

In step S506, the CPU 111 recognizes that the user of which the input ID is authenticated is in the login state.

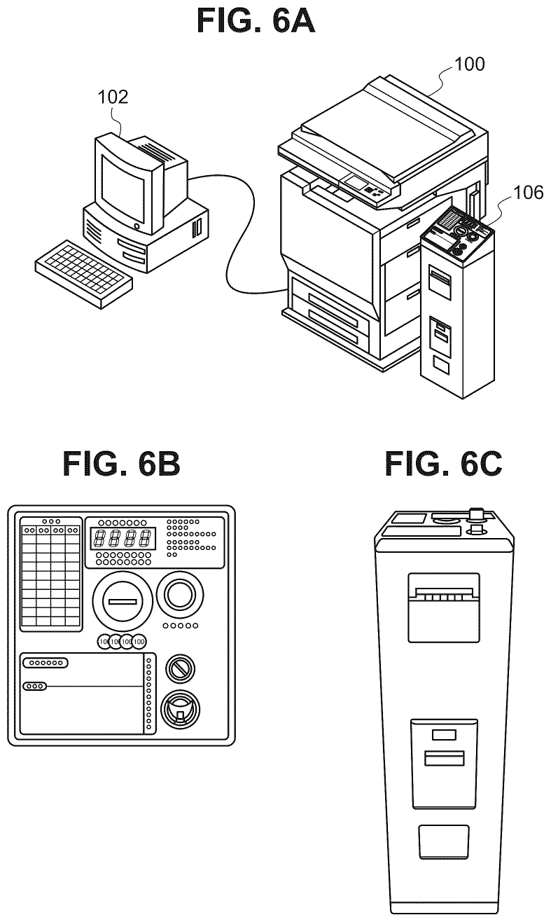

FIG. 6A illustrates a configuration of a print system including the image forming apparatus 100 according to the present exemplary embodiment. As illustrated in FIG. 6A, the printing system includes a Multi Function Peripheral (MFP) 100 supporting the charging, the charging apparatus 106, and an information processing apparatus 107. According to the present specification, the image forming apparatus 100 is an apparatus, such as an MFP and a printer, for forming an image on a recording medium such as paper.

According to the present exemplary embodiment, the mode in which the image forming apparatus 100 subjects some users to the charge processing but does not subject other users to the charge processing is referred to as a half public mode. Of users sharing the image forming apparatus 100 in the half public mode, users in a user group subjected to the charge collection at printing are referred to as charging target users, and users in a user group not subjected to the charge collection at printing are referred to as non-charging target users. The image forming apparatus 100 operates in both the public mode in which all of users of the image forming apparatus 100 are charged and the closed mode in which none of users of the image forming apparatus 100 are charged. Service personnels and administrators set one of the half public mode, the public mode, and the closed mode in which the image forming apparatus 100 will be operated.

The charging apparatus 106 collects printing charge from charging target users. FIGS. 6B and 6C are a top view and a front view, respectively, illustrating the charging apparatus 106. As illustrated in FIG. 6A, the charging apparatus 106 is generally installed near the image forming apparatus 100. Before printing, a charging target user inputs the amount of charge corresponding to the number of sheets to be printed to the charging apparatus 106.

The information processing apparatus 107 is a computer having processing capabilities. Examples of the information processing apparatus 107 include a general PC, a tablet computer, a digital camera, and other mobile and stationary terminals. Although the apparatuses to be included in the information processing apparatus 107 depend on the main purposes of these apparatuses, the information processing apparatus 107 generally includes a CPU, a ROM, a RAM, IFs, an input apparatus, and an output apparatus.

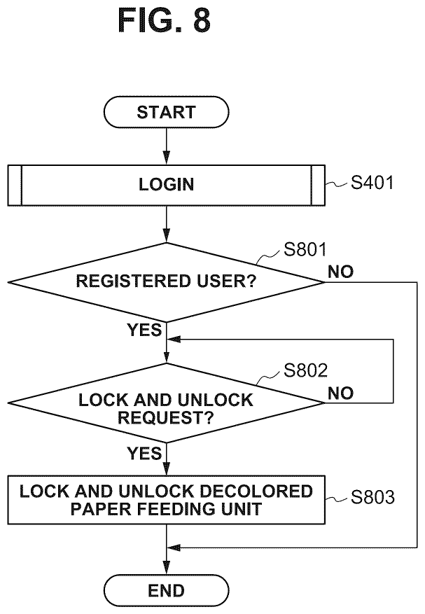

FIG. 8 is a flowchart illustrating processing for locking and unlocking the decolored paper feeding unit 124.

Processing in step S401 is similar to the processing in the same step in FIG. 4.

In step S801, the CPU 111 searches for the ID in the authentication table 301 and determines whether the login user is a registered user or a guest user. If the login user is a registered user (YES in step S801), the processing proceeds to step S802. If the login user is a guest user (NO in step S801), the processing exits this flowchart.

In step S802, the CPU 111 determines whether a request for locking and unlocking the decolored paper feeding unit 124 from the user is received from the operation unit 128. If the request is received (YES in step S802), the processing proceeds to step S803. If the request is not received (NO in step S802), the CPU 111 waits until the request is received.

In step S803, the CPU 111 transmits the locking and unlocking request to the printer control program 205, and the printer control program 205 performs the processing for locking and unlocking the decolored paper feeding unit 124 via the printer I/F 117.

The image forming apparatus 100 according to the present exemplary embodiment is assumed to be installed in libraries, convenience stores, Internet cafes, and other stores. A case where a charging target user performs a print operation by using the image forming apparatus 100 in the half public mode installed in any one of such places will be considered below. Firstly, a charging target user in each booth transmits a job from the information processing apparatus 107 (such as a PC) installed in each booth to the image forming apparatus 100. The transmitted job is temporarily stored in the image forming apparatus 100 (as a reservation job). Then, a user who has moved to the installation site of the image forming apparatus 100 inputs coins and bank notes to the charging apparatus 106 installed near the image forming apparatus 100, logs into the image forming apparatus 100 as a guest user, and operates the image forming apparatus 100 to issue an instruction for executing the reservation job. Then, the processing for printing the reservation job starts.

A store staff as a non-charging target user transmits the job from the information processing apparatus 107 to the image forming apparatus 100. Then, the staff moves to the installation site of the image forming apparatus 100, inputs the ID and password to log into the image forming apparatus 100, and operates the image forming apparatus 100 to issue an instruction for executing the reservation job. Then, the processing for printing the reservation job starts. Generally, print processing based on a reservation job is performed as follows. The user sets a password when transmitting a job to the image forming apparatus 100. At the time of executing the reservation job, the user inputs the password via the operation unit of the image forming apparatus 100.

Although a reservation job is used in the above-described example, the present exemplary embodiment is not limited to the example. For example, if a charging target user performs a copy operation (by reading a document with a scanner unit 125 and performing a print operation based on generated data), the user inputs currency to the charging apparatus 106, logs into the image forming apparatus 100 as a guest user, and operates the image forming apparatus 100 to issue an instruction for performing a copy operation. Thus, print processing of the copy operation starts. If a non-charging target user performs a copy operation, the user inputs the ID and password to log into the image forming apparatus 100, and operates the image forming apparatus 100 to issue an instruction for executing the copy operation.

Thus, print processing of the copy operation starts.

Upon completion of the print processing through the execution of a print job, the charging target user performs processing for checking off the charge for the executed print processing from the input amount of currency.

As described above, even in an environment where the half public mode is applied, the image processing apparatus 107 according to the present exemplary embodiment provides the charging target user with a print product having a certain quality, making it possible to reduce the possibility of refund.

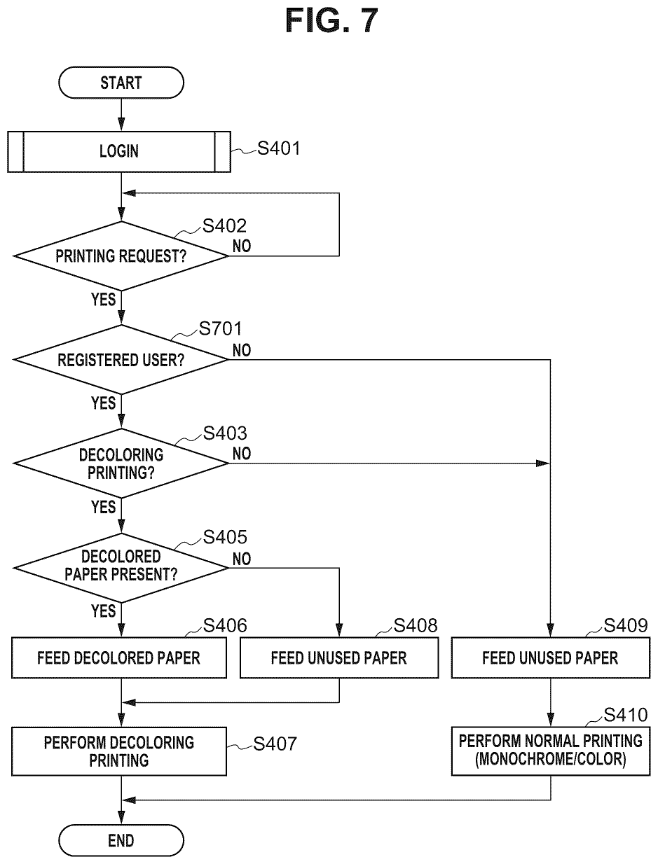

A second exemplary embodiment will be described below with reference to FIG. 7. FIG. 7 is a flowchart illustrating print processing of the image forming apparatus 100. Processing in steps S401, S402, S403, S405, S406, S407, S408, S409, and S410 is similar to the processing in the same steps in FIG. 4, and redundant descriptions of the processing will be omitted.

In step S701, the CPU 111 searches for the user ID in the authentication table 301 and determines whether the login user is a registered user or a guest user. If the login user is a registered user (YES in step S701), the processing proceeds to step S403. If the login user is a guest user (NO in step S701), the processing proceeds to step S409.

The processing of the flowchart limits the use of the decoloring print function by the guest user. This enables limiting the use of the decolored paper feeding unit 124.

The print function may also be used without the login authentication in step S401. In this case, the login user is handled as a guest user who is not permitted to use the print function in steps S404 and S701.

As described above, even in an environment where the half public mode is applied, the image processing apparatus 107 according to the present exemplary embodiment provides the charging target user with a print product having a certain quality, making it possible to reduce the possibility of refund.

The above-described exemplary embodiments are to be considered as illustrative and are not meant to limit the scope of every embodiment. These exemplary embodiments can be embodied in diverse forms and can be omitted, replaced, and modified in diverse ways without departing from the spirit and scope of the present disclosure. These exemplary embodiments and their modifications are included in the scope and spirit of the present disclosure, and similarly included within the scope of the appended claims and their equal scopes.

According to the present exemplary embodiment, FAX is an abbreviation for Facsimile, and CPU is an abbreviation for Central Processing Unit. ROM is an abbreviation for Read Only Memory, RAM is an abbreviation for Random Access Memory, and USB is an abbreviation for Universal Serial Bus. HDD is an abbreviation for Hard Disk Drive, SSD is an abbreviation for Solid State Drive, and eMMC is an abbreviation for Embedded Multi Media Card. OS is an abbreviation for Operating System.

While the present disclosure has specifically described exemplary embodiments, the spirit and scope of the present disclosure are not limited to specific descriptions within the present specification.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-138696, which was filed on Aug. 29, 2023 and which is hereby incorporated by reference herein in its entirety.

What is claimed is:

1. An image forming apparatus comprising:
a printer configured to execute first print processing using a decolorable recording material or second print processing using a undecolorable recording material;
a first paper feed stage loaded with decolored paper with a printed image having been decolored; and
a second paper feed stage loaded with unused paper,
wherein, in a case where a user for whom charge submission processing is executed through a single login to the image forming apparatus executes print processing, the printer uses the second paper feed stage but does not use the first paper feed stage.

2. The image forming apparatus according to claim 1, further comprising controller configured to control whether to execute the first print processing,
wherein the control unit does not permit the user to perform the first print processing.

3. The image forming apparatus according to claim 2, wherein the control unit permits a different user for whom charge submission processing is not executed through a single login to the image forming apparatus to perform the first print processing.

4. The image forming apparatus according to claim 3, wherein, in a case where the different user performs the print processing, the printer is capable of using the first and the second paper feed stages.

5. The image forming apparatus according to claim 1, further comprising a first reception interface (IF) configured to receive a charge submission,
wherein the controller receives a charge submission via the first reception IF and executes login authentication, and
wherein the image forming apparatus receives a charge submission via the first reception IF so that the login authentication is executed on the user.

6. The image forming apparatus according to claim 3, further comprising a second reception IF configured to receive information for identifying an individual,
wherein the controller receives information for identifying an individual via the second reception IF and executes login authentication, and
wherein the image forming apparatus receives information for identifying an individual via the second reception IF so that login authentication for identifying an individual is executed on the different user.

7. The image forming apparatus according to claim 1, wherein the first paper feed stage is a lockable paper feed stage.

8. A method for controlling an image forming apparatus that includes a printer configured to execute first print processing using a decolorable recording material or second print processing using a undecolorable recording material, a first paper feed stage loaded with decolored paper with a printed image having been decolored, and a second paper feed stage loaded with unused paper, the method comprising:
executing, for a user, charge submission processing through a single login to the image forming apparatus; and
in a case where the user for whom charge submission processing is executed through a single login to the image forming apparatus executes print processing, controlling the printer to use the second paper feed stage but does not use the first paper feed stage.

9. The method for controlling the image forming apparatus according to claim 8, further comprising controlling whether to permit the user to execute the first print processing,
wherein the user is not permitted to execute the first print processing.

10. The method for controlling the image forming apparatus according to claim 9, further comprising:
controlling to permit different user for whom charge submission processing is not executed through a single login to the image forming apparatus to execute the first print processing.

11. The method for controlling the image forming apparatus according to claim 10, further comprising:
in a case where the different user performs the print processing, controlling the printer to permit using the first and the second paper feed stages.

12. The method for controlling the image forming apparatus according to claim 8, wherein the first paper feed stage is a lockable paper feed stage.
